(19) United States
(12) Patent Application Publication
(10) Pub. No.: US 2022/0380231 A1
(43) Pub. Date: Dec. 1, 2022

(54) OIL, WATER AND SOLID IMPURITY SEPARATION DEVICE CAPABLE OF REALIZING CRUDE OIL GATHERING AND TRANSFERRING

(71) Applicant: Karamay Xinzhong Petroleum Engineering Technology Service Co., Ltd., Karamay City (CN)

(72) Inventors: Jiacun FENG, Karamay City (CN); Jiarui ZHAO, Karamay City (CN); Xiang Ml, Karamay City (CN)

(73) Assignee: Karamay Xinzhong Petroleum Engineering Technology Service Co., Ltd., Karamay City (CN)

(21) Appl. No.: 17/522,589

(22) Filed: Nov. 9, 2021

(30) Foreign Application Priority Data
May 26, 2021 (CN) 202110576430.8

(51) Int. Cl. C02F 1/38; C02F 1/00

(52) U.S. Cl. CPC C02F 1/38; C02F 1/001; C02F 2101/325

(57) ABSTRACT

An oil, water, and solid impurity separation device capable of realizing crude oil gathering and transferring is provided, which includes: a centrifuge including a liquid mixing inlet communicated to an inside thereof, and pure crude oil outlets disposed at two sides of the liquid mixing inlet and used for injecting a filtered liquid; a strainer, an input end of which is connected with one pure crude oil outlet through a pipeline, a vacuum power assembly for providing power is arranged on the pipeline; a filtering assembly, an input end of which is connected with an output end of the strainer, two individual branches are formed by an output part of the filtering assembly and an oil discharging assembly, as well as the output part of the filtering assembly and an impurity discharging assembly, respectively; one branch is an oil outlet, and another branch is an impurity outlet.

### CROSS REFERENCE TO RELATED APPLICATION

This patent application claims the benefit and priority of Chinese Patent Application No. 202110576430.8 filed on May 26, 2021, the disclosure of which is incorporated by reference herein in its entirety as part of the present application.

### TECHNICAL FIELD

The disclosure belongs to the field of crude oil separation technologies, and particularly relates to an oil, water and solid impurity separation device capable of realizing crude oil gathering and transferring.

### BACKGROUND ART

With the continuation of the development and production demand of new and old oil fields and the use of various production increasing measures of the tertiary oil recovery, the dehydration and impurity removal of the crude oil in the produced liquid of oil wells have become the main problems existing in metering, pipe transferring, oil transfer stations and centralized processing stations.

Because the diversification of production and efficiency increasing measures for old blocks and old oil wells, the wide application of various chemical assistants, the gradual aggravation of the sand production of oil wells and the like, the crude oil that is transferred via a pipe to various oil transfer stations and centralized treatment stations cannot realize the complete separation of oil, water and solid impurities. The reasons are as follows. The produced liquid is mixed with too many substances, which contains the crude oil with different property components; the silt; the polymer such as gelatin, jelly and microsphere and the like; the high polymer material with the functions of reducing condensation and viscosity and increasing production; the flocculating adhesive objects that are formed after the reaction of various chemical components (such as suspending agent) and the reservoir. Furthermore, these substances mostly migrate in the produced liquid in manner of forming a bubble shape, and just become the best traveling bag for wrapping oil particles and water molecules. So, the demulsifier cannot completely separate the crude oil and the produced water, thereby causing a large amount of crude oil with water and solid wastes to be used as the waste liquid, and enabling the waste liquid to be treated by environmental protection departments, which generates a large amount of oil loss and the unnecessary waste. Meanwhile, there exists the problem that the quality of crude oil is poor due to incomplete dehydration of the delivered crude oil, and the owner is difficult to deliver the poor crude oil to the downstream refining process. In addition, the difficulty of the post-treatment of the sewage is increased due to the mixed sewage that is incompletely separated.

### SUMMARY

The disclosure aims to provide an oil, water and solid impurity separation device capable of realizing crude oil gathering and transferring, so as to solve the problems in the background art.

In order to achieve the purpose, the disclosure provides the following technical scheme. An oil, water and solid impurity separation device capable of realizing crude oil gathering and transferring is provided, which includes a centrifuge comprising a liquid mixing inlet communicated to an inside thereof and pure crude oil outlets disposed at two sides of the liquid mixing inlet; and the pure crude oil outlets are used for injecting a filtered liquid; a strainer, an input end of which is connected with one of the pure crude oil outlets through a first pipeline; and a vacuum power assembly for providing power is arranged on the first pipeline; a filtering assembly, an input end of which is connected with an output end of the strainer; and two individual branches are formed by an output part of the filtering assembly and an oil discharging assembly, as well as the output part of the filtering assembly and an impurity discharging assembly, respectively; wherein one of the two branches is an oil outlet, and another one of the two branches is an impurity outlet; wherein the filtering assembly includes an oil-water separation tower, a vacuum separation tank and a low-power heater; an output end of the low-power heater is connected with the output end of the strainer through a second pipeline; a filter, a demulsifying device and a coalescence separation device which are sequentially connected are arranged inside the oil-water separation tower; the output end of the low-power heater is connected with an input end of the filter through a third pipeline; and an output end of the coalescence separation device is connected with an output end of the vacuum separation tank through a fourth pipeline; the oil discharging assembly includes a particle filter with a fine filtering function; the particle filter is connected with an oil outlet through a fifth pipeline; an oil pump for providing power is arranged at a joint of the oil outlet and the fifth pipeline; and the coalescence separation device, the oil pump and the particle filter form an oil outlet branch; the impurity discharging subassembly includes a condensing box configured for recovering condensing water in the vacuum separation tank; an output end of the condensing box is connected with a sixth pipeline on which a vacuum pump is arranged; a bottom of the condensing box is provided with an outlet of the condensing water; the vacuum separation tank, the condensing box, the vacuum pump and the outlet of the condensing water form an impurity outlet branch.

Preferably, the fifth pipeline at an output end of the particle filter and the second pipeline at the output end of the strainer are communicated with a circulating pipe; liquid in the circulating pipe flows to the low-power heater; wherein the circulating pipe is provided with a power pump for driving the liquid to be transmitted.

Preferably, the particle filter, the circulating pipe and the filtering assembly form a circulating branch.

Preferably, the filter in the oil-water separation tower includes a primary filter and a secondary filter which are communicated with each other; and the secondary filter is connected with the demulsifying device.

Preferably, the vacuum separation tank includes a spray device, a three-dimensional flash tower and a condensation and separation device; the three-dimensional flash tower is a downstream unit of the spray device; the condensation and separation device is a downstream unit of the three-dimensional flash tower; and the condensation and separation device is communicated with the condensing box.

Preferably, the centrifuge further includes slag outlets, water outlets and dishing sheets; the dishing sheets are centrally symmetrical with respect to the liquid mixing inlet and are obliquely distributed in the centrifuge; the slag outlets are penetratedly provided in a middle of the centrifuge; and the water outlets are arranged on two sides of the centrifuge and are located at a bottom of the pure crude oil outlet.

Preferably, the vacuum power assembly includes a vacuum valve.

Preferably, a side of the condensing box which is away from the vacuum pump is opened with a lateral groove; an impact plate is provided in the lateral groove; inner limiting plates are fixed symmetrically on an inner wall of lateral groove at an opening of the lateral groove; built-in springs are provided between inner limiting plates and the impact plate; each of two ends of the impact plate is partially overlapped with a corresponding one of the inner limiting plates; a columnar body, which is perpendicular to the impact plate, is fixed on a surface of the impact plate which faces toward the opening of the lateral groove; another inner wall of the lateral groove is provided with spaced-apart protrusions; and the spaced-apart protrusions are hemispheroidal structures.

Compared with the prior art, the disclosure has the beneficial effects as follows.

1. By the design of the disclosure, the problems that the separation of oil, water and solid impurities is difficult, the treatment cost is high and the crude oil in the mixed liquid cannot be fully recovered are thoroughly solved.

2. Through the impact plate, the water droplets that are on inner walls of the condensing box inner wall are quickly fallen off via the vibration, thereby achieving the quick liquid discharge and no residue. Furthermore, the spaced-apart protrusions can not only transmit magnitude of the force, but also decrease the contact surface, which avoids damage caused by the excessive impact surface.

### BRIEF DESCRIPTION OF THE DRAWINGS

FIG. 1 is a schematic structural view according to an embodiment of the present disclosure;

FIG. 2 is a cross-sectional view of a centrifuge according to an embodiment of the present disclosure;

FIG. 3 is a cross-sectional view of a condensing box according to an embodiment of the present disclosure; and

FIG. 4 is an enlarged view of a detailed area A of FIG. 3 according to an embodiment of the present disclosure.

Reference numerals in drawings: 1. particulate filter; 2. oil-water separation tower; 3. vacuum separation tank; 4. condensing box; 5. vacuum pump; 6. centrifuge; 61. slag outlet; 62. water outlet; 63. pure crude oil outlet; 64. liquid mixing inlet; 65. dishing sheets; 7. strainer; 8. low-power heater; 9. oil pump; 10. circulating pipe; 11. built-in spring; 12. inner limiting plate; 13. impact plate; 14. lateral groove; 15. spaced-apart protrusion.

### DETAILED DESCRIPTION OF THE EMBODIMENTS

The technical solutions in the embodiments of the present disclosure will be clearly and completely described below with reference to the drawings in the embodiments of the present disclosure. It is obvious that the described embodiments are only a part of the embodiments of the present disclosure, rather than all the embodiments. All other embodiments, which can be derived by a person skilled in the art from the embodiments given herein without making any creative effort, shall fall within the protection scope of the present disclosure.

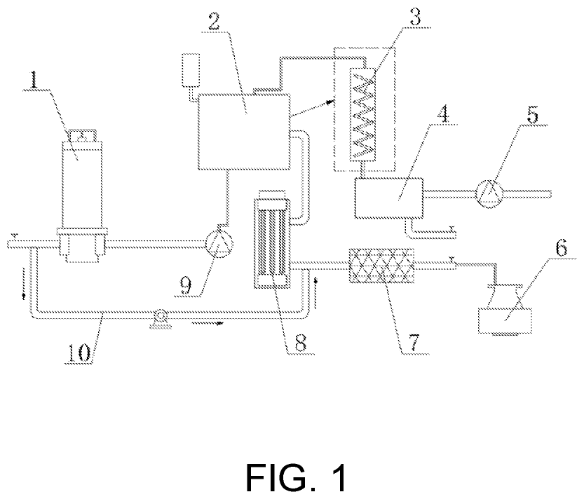

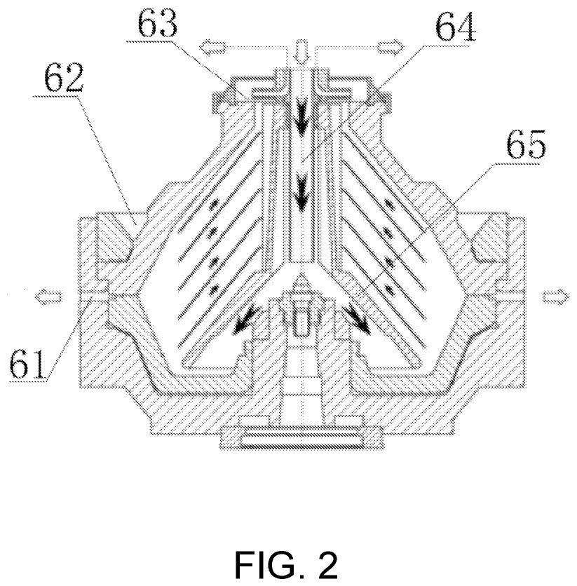

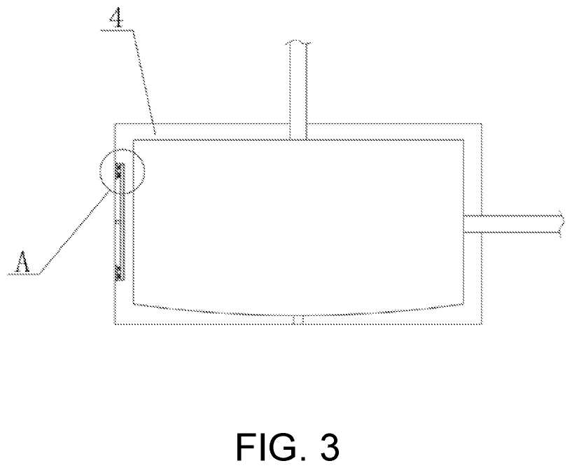

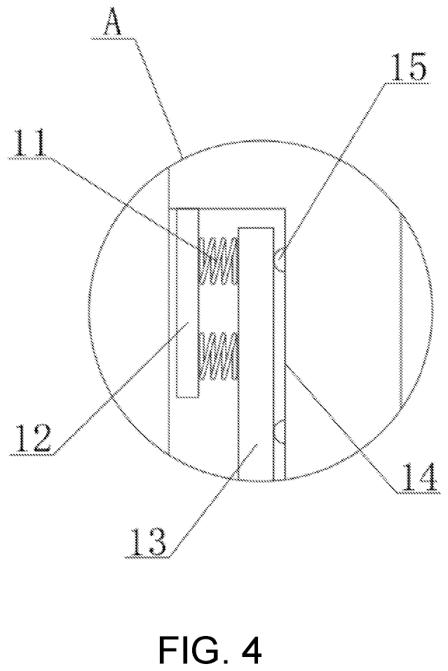

Referring to FIGS. 1 to 4, a technical solution is provided as follows. An oil, water and solid impurity separation device capable of realizing crude oil gathering and transferring is provided, which includes a centrifuge 6, a strainer 7 and a filtering assembly. The centrifuge 6 includes a liquid mixing inlet 64 communicated to an inside thereof and pure crude oil outlets 63 disposed at two sides of the liquid mixing inlet 64. The pure crude oil outlets 63 are used for injecting a filtered liquid. An input end of the strainer 7 is connected with one of the pure crude oil outlets 63 through a pipeline. A vacuum power assembly for providing power is arranged on the pipeline. An input end of the filtering assembly is connected with an output end of the strainer 7. Two individual branches are formed by an output part of the filtering assembly and an oil discharging assembly, as well as the output part of the filtering assembly and an impurity discharging assembly, respectively. One of the two branches is an oil outlet, and an other one of the two branches is an impurity outlet.

The filtering assembly includes an oil-water separation tower 2, a vacuum separation tank 3 and a low-power heater 8. An output end of the low-power heater 8 is connected with the output end of the strainer 7 through a pipeline. A filter, a demulsifying device, and a coalescence separation device which are sequentially connected are arranged inside the oil-water separation tower 2. The output end of the low-power heater 8 is connected with an input end of the filter through a pipeline. An output end of the coalescence separation device is connected with an output end of the vacuum separation tank 3 through a pipeline.

The oil discharging assembly includes a particle filter 1 with a fine filtering function. the particle filter 1 is connected with an oil outlet through a pipeline. An oil pump 9 for providing power is arranged at a joint of the oil outlet and the pipeline. The coalescence separation device, the oil pump 9 and the particle filter 1 form an oil outlet branch.

The impurity discharging subassembly includes a condensing box 4 configured for recovering condensing water in the vacuum separation tank 3. An output end of the condensing box 4 is connected with a pipeline on which a vacuum pump 5 is arranged. A bottom of the condensing box 4 is provided with an outlet of the condensing water. The vacuum separation tank 3, the condensing box 4, the vacuum pump 5 and the outlet of the condensing water form an impurity outlet branch. In this way, the problems that the separation of oil, water and solid impurities is difficult, the treatment cost is high and the crude oil in the mixed liquid cannot be fully recovered are thoroughly solved.

In this embodiment, it is preferable that a circulation pipe 10 is connected to the pipelines at the output ends of both the particle filter 1 and the strainer 7. The liquid in the circulation pipe 10 flows toward the low-power heater 8, so that the unqualified finished product can be returned to the filtering assembly again for secondary processing or multiple processing. The circulating pipe 10 is provided with a power pump for driving the liquid to be transmitted.

In this embodiment, it is preferable that the particle filter 1, the circulating pipe 10 and the filtering assembly form a circulating branch.

In this embodiment, it is preferable that the filter in the oil-water separation tower 2 includes a primary filter and a secondary filter which are communicated with each other. The secondary filter is connected with the demulsifying device.

In this embodiment, it is preferable that the vacuum separation tank 3 includes a spray device, a three-dimensional flash tower and a condensation and separation device. The three-dimensional flash tower is a downstream unit of the spray device. The condensation and separation device is a downstream unit of the three-dimensional flash tower; and the condensation and separation device is communicated with the condensing box 4.

In this embodiment, preferably, the centrifuge 6 further includes slag outlets 61, water outlets 62 and dishing sheets 65. The dishing sheets 65 are centrally symmetric with respect to the liquid mixing inlet 64 and are obliquely distributed in the centrifuge 6. During processing, a strong centrifugal force is generated inside the centrifuge 6. So, multiple components with different densities are formed to be a circular ring shape under the action of the centrifugal force. Furthermore, solid particles with the highest density move outwards and are accumulated on the peripheral wall of the drum. In addition, because the centrifugal force generated by the high-speed rotation of the drum is far greater than the gravity, there needs very little time for the centrifugal separation of the light-phase liquid at the innermost layer, and thus the gravity separation can be achieved. The slag outlets 61 are communicated with each other in a middle of the centrifuge 6. The water outlets 62 are arranged on two sides of the centrifuge 6 and are at a bottom of the pure crude oil outlet 63.

In this embodiment, the vacuum power assembly preferably includes a vacuum valve.

In this embodiment, preferably, a side of the condensing box 4 which is away from the vacuum pump 5 is opened with a lateral groove 14. An impact plate 13 is provided in the lateral groove 14. Through this impact plate 13, the water droplets that are on inner walls of the condensing box inner wall are quickly fallen off by the vibration, thereby achieving the quick liquid discharge and no residue. Furthermore, the spaced-apart protrusions can not only transmit the magnitude of the force, but also decrease the contact surface, which avoids damage caused by the excessive impact surface. Inner walls of lateral groove 14 which are at an opening thereof are fixed symmetrically with inner limiting plates 12. Built-in springs 11 are provided between inner limiting plates 12 and the impact plate 13. Each of two ends of the impact plate 13 is partially overlapped with a corresponding one of the inner limiting plates 12. A columnar body, which is perpendicular to the impact plate, is fixed on a surface of the impact plate 13 which faces toward the opening of the lateral groove 14. Another inner wall of the lateral groove 14 is provided with spaced-apart protrusions 15. The spaced-apart protrusions are hemispheroidal structures.

The working principle and the using process of the disclosure are as follows. During usage, to-be-separated materials are injected from the liquid mixing inlet 64, and enter into the inside of the drum of the centrifuge. Under the action of a strong centrifugal force field, the materials flow through a separation interval formed by a bundle consisting of a group of dishing sheets 65, and flow from bottom ends of the dishing sheets 65 to top ends of the dishing sheets 65. Furthermore, the solids with a lager specific gravity are moved along the walls of the dishing sheets 65 to the bottom ends, accumulated in sediment areas at a bottom of the centrifuge, and then automatically discharged out of the centrifuge via the slag outlets regularly. The liquid with a smaller specific gravity is moved to the top ends along the walls of the dishing sheets 65 until the liquid converges to the centripetal pump at a top of the drum. This liquid then is discharged via the pure oil outlets 63 to be output to a next process. When the centrifuge is working, if the separated crude oil does not satisfy the requirement of the oil in the ideal state, the separated crude oil enters into the strainer 7 under the action of the negative pressure formed by the vacuum system. The oil enters into the low-power heater 8 after larger particles of impurities are filtered out from the oil. The oil after being heated enters into the oil-water separation tower 2, and the impurities in the oil are filtered out via the oil-water separation tower 2. Then, the oil enters into the primary filter and the secondary filter, so as to filter out the fine impurities in the oil. The oil then enters into the demulsifying device, and the oil molecules and the water molecules are completely separated by cutting off the molecular chain of the emulsified oil. The oil is subjected to the water separation treatment via the coalescence separation device. Because the filter element of the oil-water separation tower adopts enhanced lipophilic and hydrophobic technology, the interaction force on the oil-water interface is changed, so that the movement of the fine water droplets in the oil is accelerated. In addition, the fine water droplets after being accelerated are aggregated into larger water droplets to separate and precipitate from the oil, and settled in bottom portions of both the primary filter and the secondary filter to discharge via the drain valve. The oil enters into the vacuum separation tank 3. In the vacuum separation tank 3, by using the three-dimensional vacuum flash technology, the oil is formed to be a thin oil film via the spray device. The oil film forms a cone with a large aeration area on the three-dimensional flash tower. The moisture, the gas, and the light hydrocarbons in the oil are fully evaporated and removed, by increasing the aeration area and the residence time of the oil in the high vacuum state. The water, the gas and the light hydrocarbons after being evaporated are cooled by the condensation and separation device, and then discharged via the vacuum pump 5. The oil from which the moisture and the gas has been removed is output by the oil pump 9, and finally enters into the particle filter 1. In the particle filter 1, the particle impurities are filtered out from the oil, and thus the process for fully separating three phases is completed finally. After the above process is completed, when the quality of the finished product is still low, the processing is performed again by the circulating pipe 10. In usage, water droplets are condensed on the inner walls of the condensing box 4. At this time, the columnar body is pulled to enable the impact plate 13 to move toward the inner limiting plates 12 and thus squeeze the built-in springs 11. Then, the columnar body is released. Under the rebound of the built-in springs 11, the impact plate 13 move toward the lateral groove 14, and transmits the resilience force of the built-in springs 11 to the spaced-apart protrusions 15. The spaced-apart protrusions 15 drive the entire condensing box 4 to vibrate, thereby vibrating and falling off the water droplets condensed on the inner walls of the condensing box 4. Although embodiments of the present disclosure have been shown and described, it will be appreciated by those skilled in the art that changes, modifications, substitutions and alterations can be made in these embodiments without departing from the principles and spirit of the disclosure. The scope of the disclosure is defined by the appended claims and their equivalents.

1. An oil, water, and solid impurity separation device capable of realizing crude oil gathering and transferring, comprising:
a centrifuge comprising a liquid mixing inlet communicated to an inside thereof and pure crude oil outlets disposed at two sides of the liquid mixing inlet; and through the pure crude oil outlets, a filtered liquid being injected;
a strainer, an input end of which is connected with one of the pure crude oil outlets through a first pipeline; and a vacuum power assembly for providing power being arranged on the first pipeline;
a filtering assembly, an input end of which is connected with an output end of the strainer; and two individual branches being formed between an output part of the filtering assembly and an oil discharging assembly, and between the output part of the filtering assembly and an impurity discharging assembly, respectively; wherein one of the two branches is an oil outlet, and another one of the two branches is an impurity outlet;
wherein the filtering assembly comprises an oil-water separation tower, a vacuum separation tank and a low-power heater; an output end of the low-power heater is connected with the output end of the strainer through a second pipeline; a filter, a demulsifying device and a coalescence separation device which are sequentially connected are arranged inside the oil-water separation tower; the output end of the low-power heater is connected with an input end of the filter through a third pipeline; and an output end of the coalescence separation device is connected with an output end of the vacuum separation tank through a fourth pipeline;
the oil discharging assembly comprises a particle filter with a fine filtering function; the particle filter is connected with an oil outlet through a fifth pipeline; an oil pump for providing power is arranged at a joint of the oil outlet and the fifth pipeline; and the coalescence separation device, the oil pump and the particle filter form an oil outlet branch;
the impurity discharging subassembly comprises a condensing box configured for recovering condensing water in the vacuum separation tank; an output end of the condensing box is connected with a sixth pipeline on which a vacuum pump is arranged; a bottom of the condensing box is provided with an outlet for the condensing water; the vacuum separation tank, the condensing box, the vacuum pump and the outlet of the condensing water form an impurity outlet branch.

2. The oil, water and solid impurity separation device capable of realizing crude oil gathering and transferring according to claim 1, wherein the fifth pipeline at an output end of the particle filter and the second pipeline at the output end of the strainer are communicated with a circulating pipe; liquid in the circulating pipe flows to the low-power heater; wherein the circulating pipe is provided with a power pump for driving the liquid to be transmitted.

3. The oil, water and solid impurity separation device capable of realizing crude oil gathering and transferring according to claim 2, wherein the particle filter, the circulating pipe and the filtering assembly form a circulating branch.

4. The oil, water and solid impurity separation device capable of realizing crude oil gathering and transferring according to claim 1, wherein the filter in the oil-water separation tower comprises a primary filter and a secondary filter which are communicated with each other; and the secondary filter is connected with the demulsifying device.

5. The oil, water and solid impurity separation device capable of realizing crude oil gathering and transferring according to claim 1, wherein the vacuum separation tank comprises a spray device, a three-dimensional flash tower and a condensation and separation device; the three-dimensional flash tower is a downstream unit of the spray device; the condensation and separation device is a downstream unit of the three-dimensional flash tower; and the condensation and separation device is communicated with the condensing box.

6. The oil, water and solid impurity separation device capable of realizing crude oil gathering and transferring according to claim 1, wherein the centrifuge further comprises slag outlets, water outlets and dishing sheets; the dishing sheets are centrally symmetrical with respect to the liquid mixing inlet and are obliquely distributed in the centrifuge; the slag outlets are penetratedly provided in a middle of the centrifuge; and the water outlets are arranged on two sides of the centrifuge and are located at a bottom of the pure crude oil outlet.

7. The oil, water and solid impurity separation device capable of realizing crude oil gathering and transferring according to claim 1, wherein the vacuum power assembly includes a vacuum valve.

8. The oil, water and solid impurity separation device capable of realizing crude oil gathering and transferring according to claim 1, wherein a side of the condensing box which is away from the vacuum pump is opened with a lateral groove; an impact plate is provided in the lateral groove; inner limiting plates are symmetrically fixed on an inner wall of lateral groove at an opening of the lateral groove; built-in springs are provided between inner limiting plates and the impact plate; each of two ends of the impact plate is partially overlapped with a corresponding one of the inner limiting plates; a columnar body, which is perpendicular to the impact plate, is fixed on a surface of the impact plate which faces toward the opening of the lateral groove; another inner wall of the lateral groove is provided with spaced-apart protrusions; and the spaced-apart protrusions are hemispheroidal structures.
